(19) United States
(12) Patent Application Publication
(10) Pub. No.: US 2023/0410124 A1
(43) Pub. Date: Dec. 21, 2023

(54) METHOD AND PROCESSING UNIT FOR FORGING A SHIELD TO CERTIFY A USER WITH A TECHNICAL SKILL

(71) Applicant: SINDRI LLC, Troutville, VA (US)

(72) Inventors: James Samuel Flint, Troutville, VA (US); Alfred Joseph Gracias, Suwanee, GA (US)

(21) Appl. No.: 17/844,066

(22) Filed: Jun. 20, 2022

(51) Int. Cl. G06Q 30/00

(52) U.S. Cl. CPC G06Q 30/018

(57) ABSTRACT

A method, a processing unit, and a non-transitory computer-readable medium for forging a shield to certify a user with a technical skill are disclosed. For forging the shield, initially, a request is obtaining from a user to forge shield for a selected technical skill and a skill level. In response to request, simulated environment is presented to the user, where the simulated environment is generated using a set of required infrastructures and technical skill components along with at-least one dynamically created problem for conducting an assessment of the user for the selected technical skill. The problem for the simulated environment is chosen based on the skill level. Upon submission of the assessment, the assessment is evaluated based on end state of the simulated environment. Based on the evaluation of the assessment, a shield to certify the user to possess the selected technical skill with the skill level is forged.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE PRESENT DISCLOSURE

Embodiments of the present invention generally relate to certifying a user for a technical skill. In particular, embodiments of the present invention relate to a method and processing unit for forging a shield to certify a user with a technical skills using a simulated environment.

### BACKGROUND OF THE DISCLOSURE

Skill certifications are issued to a user as a credential when a user is verified to have competency to perform a job related to a skill. Many entities rely on such certificates for taking calls with regards to career of a person. For example, for hiring a candidate, skill certificates of the candidate add a weightage to profile of the candidate. The process of certification may include training a user for a particular skill and further conducting a test to assess competency of the user for said skill. Some certifications directly conduct test/assessment of skills of user. Based on the performance of the candidate during the training and the test, the skill certificate may be issued to the user. In some cases, the skill certificate may also indicate skill level of the candidate for the particular skill.

Skill certification may be issued for a user's both hard skills. Hard skills include technical skills, computer skills, management skills, analytical skills and so on. Specifically, certification for technical skills is quit commonly done nowadays. To obtain a certification in a technical skill, a user may have to enroll for a test and pass the test. Existing certification providers conduct a test typically with multiple questions to be answered by the user. The questions maybe multiple choice questions, subjective questions, or theoretical questions for which the user needs to be provide answers. The answers are evaluated to score the user and issue the certificate.

In many cases, such evaluation may be not efficient and may not certify if the user is skilled enough to handle real-world problems associated with the technical skill. Actual skills of the user may be determined accurately based on user being able to solve the real-world problems in real-time scenarios. Thus, theoretically questioning may not serve the purpose of assessing the user for the technical skills.

Some conventional skill certifying systems teach to train and assess the user by providing a real-time projects. Such projects mostly relate to finance sector and the user may be able to take assessment with spreadsheets. Providing real-time projects for a user who needs to get assessed for some of the technical skills like DevOps, system engineers, Site Reliability Engineering (SRE), operator engineering, Full stake developers, Amazon Web Services (AWS) architects, Google Cloud Platform (GCP), Azure architects, Hashi stack and so on, may be challenging since provisioning the required infrastructure for such technical skills is complex. The user may not have access to the required software components and infrastructure to work like in an actual environment of such technical skills.

The information disclosed in this background of the disclosure section is only for enhancement of understanding of the general background of the disclosure and should not be taken as an acknowledgment or any form of suggestion that this information forms existing information already known to a person skilled in the art.

### BRIEF SUMMARY OF THE DISCLOSURE

A method, a processing unit, and a non-transitory computer-readable medium for forging a shield to certify a user with a technical skill. For forging the shield, initially, a request is obtaining from a user to forge a shield for a selected technical skill and a skill level. In response to the request, a simulated environment is presented to the user, where the simulated environment is generated using a set of required infrastructures and technical skill components along with at-least one dynamically created problem for conducting an assessment of the user for the selected technical skill. The problem for the simulated environment is chosen based on the skill level. Upon submission of the assessment, the assessment is evaluated based on end state of the simulated environment. Based on the evaluation of the assessment, a shield to certify the user to possess the selected technical skill with the skill level is forged.

In an embodiment, options containing a plurality of technical skills, and optionally a plurality of skill levels is displayed to the user to obtain the request from the user.

In an embodiment, evaluating the assessment includes to generate one or more scores for the assessment based on the end state of the simulated environment.

In an embodiment, one or more user inputs provided by the user in the simulated environment during the assessment is monitored. The one or more user inputs are used for at least one of evaluating the assessment of the user, upon submission of the assessment, and detect act of cheating by the user during the assessment.

In an embodiment, the shield is forged when at least one of value of one or more scores generated for the assessment is verified to be greater than a threshold value, and the end state of the simulated environment is detected to be completed.

In an embodiment, the forged shield is published in a social platform of the user.

In an embodiment, a script is run on the simulated environment, upon submission of the assessment, to determine the end state of the simulated environment.

The features and advantages of the subject matter described hereof will become more apparent in light of the following detailed description of selected embodiments, as illustrated in the accompanying FIGUREs. As one of ordinary skill in the art will realize, the subject matter disclosed is capable of modifications in various respects, all without departing from the scope of the subject matter. Accordingly, the drawings and the description are to be regarded as illustrative.

### BRIEF DESCRIPTION OF THE DRAWINGS

The present subject matter will now be described in detail with reference to the drawings, which are provided as illustrative examples of the subject matter to enable those skilled in the art to practice the subject matter. It will be noted that throughout the appended drawings, features are identified by like reference numerals. Notably, the FIGUREs and examples are not meant to limit the scope of the present subject matter to a single embodiment, but other embodiments are possible by way of interchange of some or all of the described or illustrated elements and, further, wherein:

FIG. 1 illustrates an exemplary environment with processing unit for forging a shield to certify a user with a technical skill, in accordance with an embodiment of the present disclosure;

FIG. 2 illustrates a detailed block diagram showing functional modules of a processing unit for forging a shield to certify a user with a technical skill, in accordance with an embodiment of the present disclosure;

FIGS. 3A-3I show exemplary embodiments for forging a shield to certify a user with a technical skill, in accordance with an embodiment of the present disclosure;

FIG. 4 shows an exemplary process of processing unit for forging a shield to certify a user with a technical skill, in accordance with an embodiment of the present disclosure; and

FIG. 5 illustrates an exemplary computer unit in which or with which embodiments of the present invention may be utilized.

### DETAILED DESCRIPTION OF THE EMBODIMENTS

The detailed description set forth below in connection with the appended drawings is intended as a description of exemplary embodiments in which the presently disclosed process can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed method and system. However, it will be apparent to those skilled in the art that the presently disclosed process may be practiced without these specific details. In some instances, well-known structures and devices are shown in block diagram form in order to avoid obscuring the concepts of the presently disclosed method and system.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and firmware.

Embodiments of the present invention may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, semiconductor memories, such as ROMs, PROMs, random access memories (RAMs), programmable read-only memories (PROMs), erasable PROMs (EPROMs), electrically erasable PROMs (EEPROMs), flash memory or other types of media/machine-readable medium suitable for storing electronic instructions (e.g., computer programming code, such as software or firmware).

Various methods described herein may be practiced by combining one or more machine-readable storage media containing the code according to the present invention with appropriate standard or customized computer hardware to execute the code contained therein. An apparatus for practicing various embodiments of the present invention may involve one or more computers (or one or more processors within the single computer) and storage systems containing or having network access to a computer program(s) coded in accordance with various methods described herein, and the method steps of the invention could be accomplished by modules, routines, subroutines, or subparts of a computer program product.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

It will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

Embodiments of the present disclosure relate to a method and processing unit for forging a shield to certify a user with a technical skill. To forge shield for the user, a simulated environment related to the technical skill is generated and presented to the user for the assessment. The simulated environment is generated to include set of required infrastructure and technical skill components along with at least one dynamically created problem which is to be solved by the user to obtain the shield. The problem may be chosen based on skill level selected by the user or profile of the user. When the user submits the assessment, the assessment is evaluated based on end state of the simulated environment. Thereafter, a shield is forged based on the evaluation.

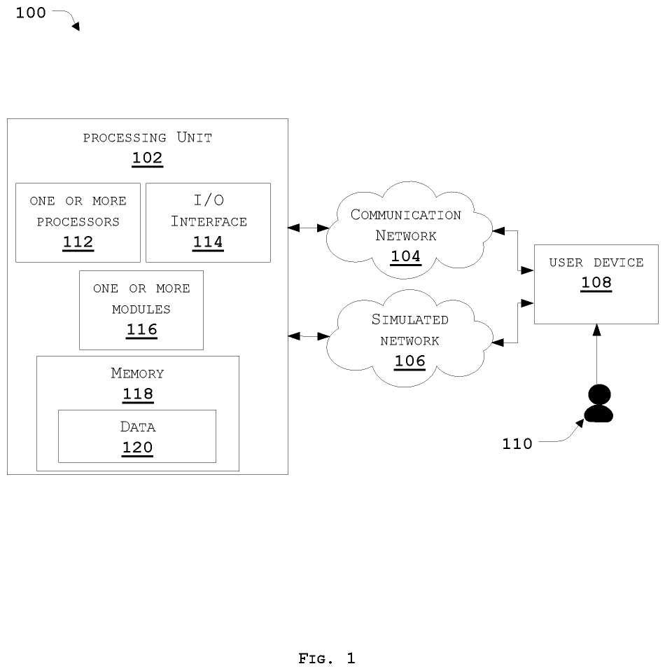

FIG. 1 illustrates an exemplary environment 100 with processing unit 102 for forging a shield to certify a user with a technical skill, in accordance with an embodiment of the present disclosure. As shown in FIG. 1, the exemplary environment 100 comprises the processing unit 102, a communication network 104, a simulated network 106, a user device 108, and a user 110. The exemplary environment 100 is established when the user requests to forge the shield to certify the user 110 in a technical skill. In an embodiment, the user 110 may be a personnel with knowledge in a technical skill and wishes to seek a certification or a badge to prove the knowledge. The user may use the user device 108 to get connected with the processing unit 102. The user device 108 may be at least one of a smartphone, a PC, tablet, laptop, a computer and so on, through which the user 110 is capable of taking the assessment conducted by the processing unit 102.

The processing unit 102 is configured forge the shield for the user 110 to certify the user 110 with a technical skill. In an embodiment, the processing unit 102 may be configured to forge a shield for the technical skill related to, but is not limited to, DevOps, system engineers, SRE, operator engineering, Full stake developers, AWS architects, GCP, Azure architects, Hashi stack and so on. The technical skill may be associated with, but is not limited to, installation, configuration and integration of systems and tools like software tools, search engines, coding, network configurations, developers' tools, software administrative tools, virtualization tools and so on. A simulation related to said installation, said configuration and said integration may be generated and used for assessing the technical skill. In an embodiment, the processing unit 102, for providing the request, may be accessed by the user 110 via a web browser. In an embodiment, the processing unit 102, for taking the assessment, may be accessed by the user 110 via an RDP terminal presented through the web browser or an RDP application. For initiating the forging of the shield, the user 110 may create an account in the web-site or the software application. The user 110 may log-in to the account to initiate the forging of the shield. In an embodiment, the exemplary environment 100 may be implemented within the user device 108 of the user 110. In an embodiment, the processing unit 102 may be communicatively coupled with the user device 108. In an embodiment, the processing unit 102 may be implemented as a dedicated server or a cloud based sever communicatively coupled with the user device 108 of the user 110.

In an embodiment, the processing unit 102 is configured to communicate with the user 110 via the communication network 104. The communication network 104 may include, without limitation, a direct interconnection, a Local Area Network (LAN), a Wide Area Network (WAN), a wireless network (e.g., using Wireless Application Protocol), the Internet, and the like. In an embodiment, the assessment to forge the shield any be conducted via the simulated network 106. In an embodiment, the simulated network 106 may be a Virtual Public Cloud (VPC) with several network building infrastructures required to conduct the assessment.

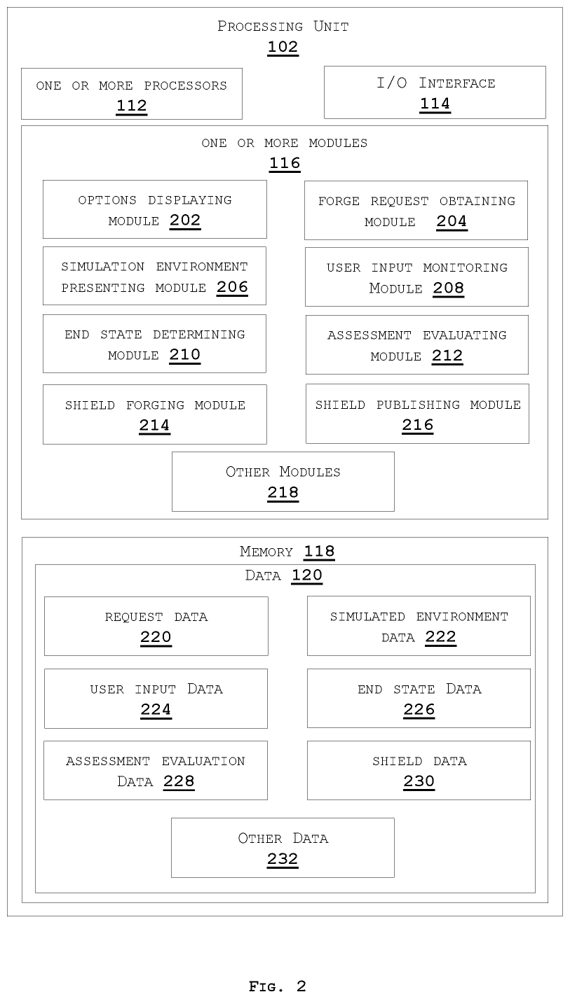

FIG. 2 shows a detailed block diagram of the processing unit 102 for forging the shield to the user 110 to certify the user 110 for a technical skill, in accordance with some non-limiting embodiments or aspects of the present disclosure. The processing unit 102 may include one or more processors 112, an Input/Output (I/O) interface 114, one or more modules 116 and a memory 118. In some non-limiting embodiments or aspects, the memory 118 may be communicatively coupled to the one or more processors 112. The memory 118 stores instructions, executable by the one or more processors 112, which on execution, may cause the processing unit 102 to forge the shield for the user 110. In some non-limiting embodiments or aspects, the memory 118 may include data 120. The one or more modules 116 may be configured to perform the steps of the present disclosure using the data 120 to forge the shield for the user 110. In some non-limiting embodiments or aspects, each of the one or more modules 116 may be a hardware unit, which may be outside the memory 118 and coupled with the processing unit 102. In some non-limiting embodiments or aspects, the processing unit 102, for obtaining the request to forge the shield, may be implemented in a variety of computing systems, such as a laptop computer, a desktop computer, a Personal Computer (PC), a notebook, a smartphone, a tablet, a server, a network server, a cloud server, and the like. In an embodiment, the processing unit 102, for presenting the simulated environment, assessing the evaluation, and forging the shield, may be implemented in a cloud computing platform such as AWS, Azure, GCP and so on. In an embodiment, the processing unit 102 may be a virtual machine which may be accessed by the user 110 via hardware platform with an operating system. In a non-limiting embodiment, each of the one or more modules 116 may be implemented with a cloud-based server, communicatively coupled with the processing unit 102.

The data 120 in the memory 118, and the one or more modules 116 of the processing unit 102 are described herein in detail. In one implementation, the one or more modules 116 may include, but is not limited to, an options displaying module 202, a forge request obtaining module 204, a simulated environment presenting module 206, a user input monitoring module 208, an end state determining module 210, an assessment evaluating module 212, a shield forging module 214, a shield publishing module 216 and one or more other modules 210 associated with the processing unit 102. In some non-limiting embodiments or aspects, the data 120 in the memory 118 may include request data 220 (herewith also referred to as request 220), simulated environment data 222 (herewith also referred to as simulated environment 222), user input data 224 (herewith also referred to one or more user inputs 224), end state data 226 (herewith also referred to end state 226), assessment evaluation data 228, shield data 230 and other data 232 associated with the processing unit 102.

In some non-limiting embodiments or aspects, the data 120 in the memory 118 may be processed by the one or more modules 116 of the processing unit 102. In some non-limiting embodiments or aspects, the one or more modules 116 may be implemented as dedicated units and when implemented in such a manner, the modules may be configured with the functionality defined in the present disclosure to result in a novel hardware. As used herein, the term module may refer to an Application Specific Integrated Circuit (ASIC), an electronic circuit, Field-Programmable Gate Arrays (FPGA), a Programmable System-on-Chip (PSoC), a combinational logic circuit, and/or other suitable components that provide the described functionality. The one or more modules 116 of the present disclosure function to conduct the assessment and forge the shield for the user 110to certify the user 110 with a technical skill. The one or more modules 116 along with the data 120, may be implemented in any system for forging the shield.

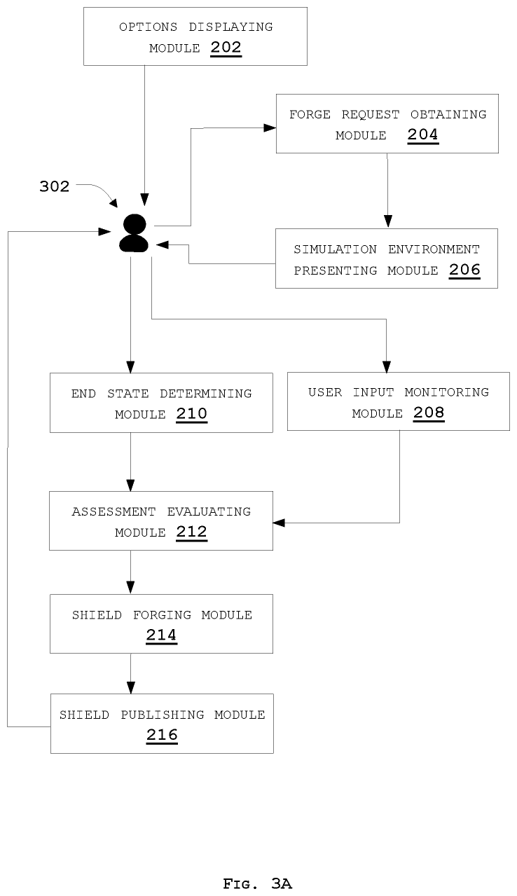

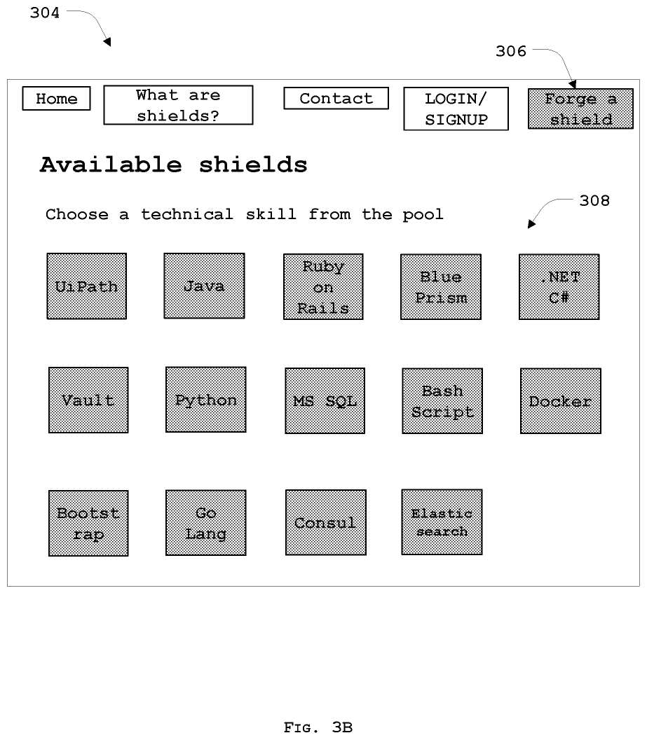

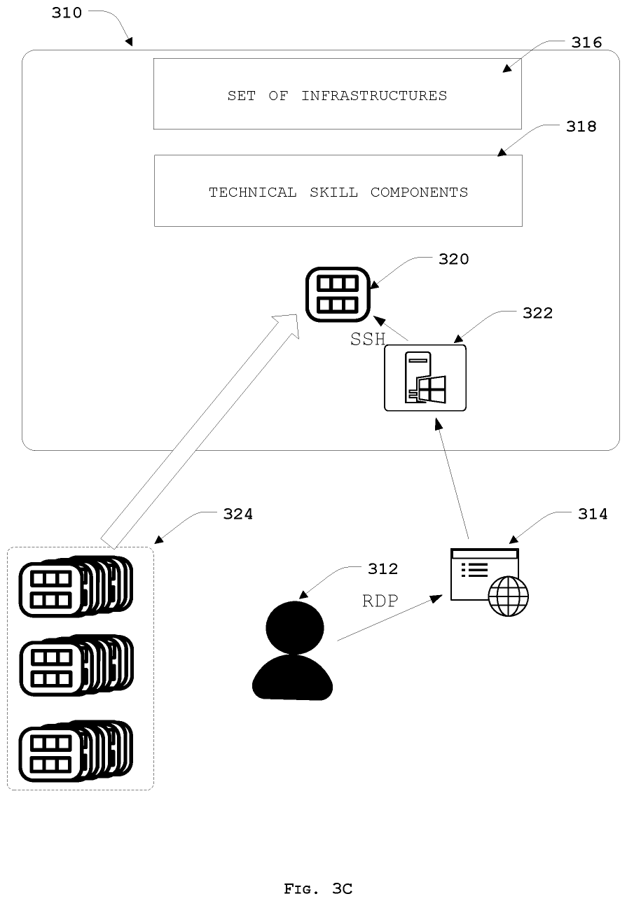

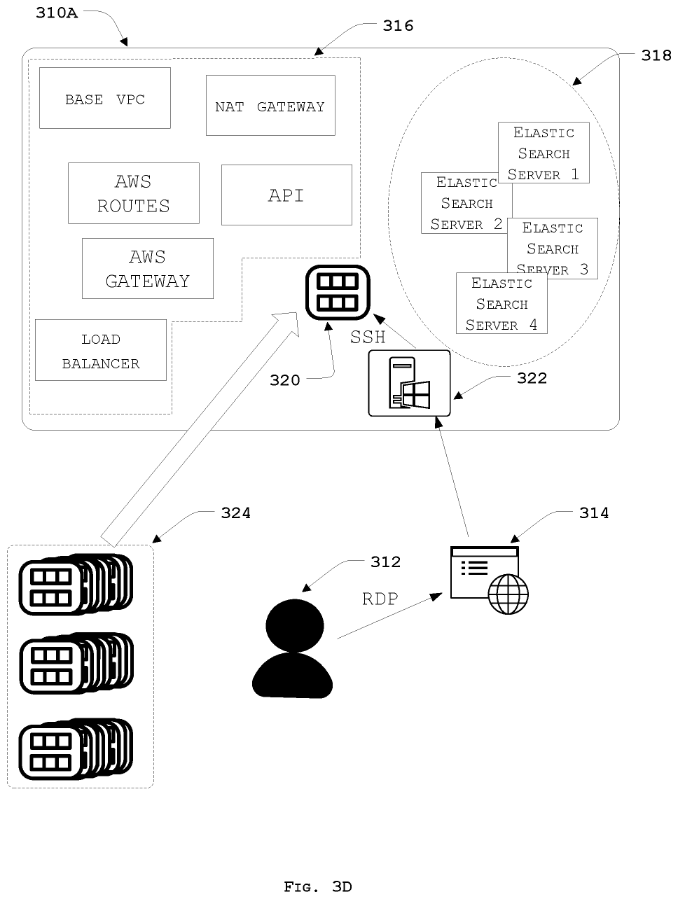

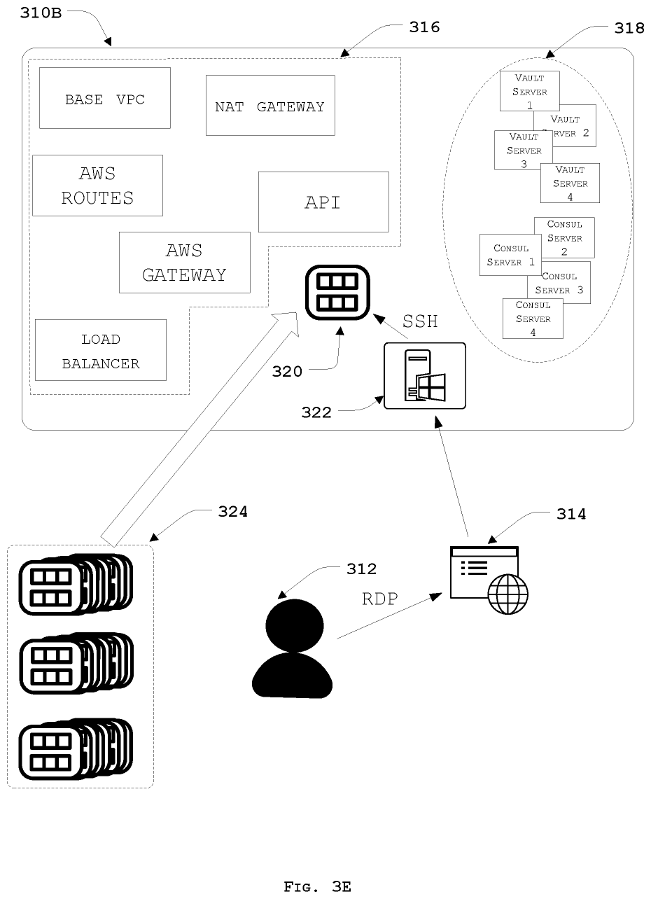

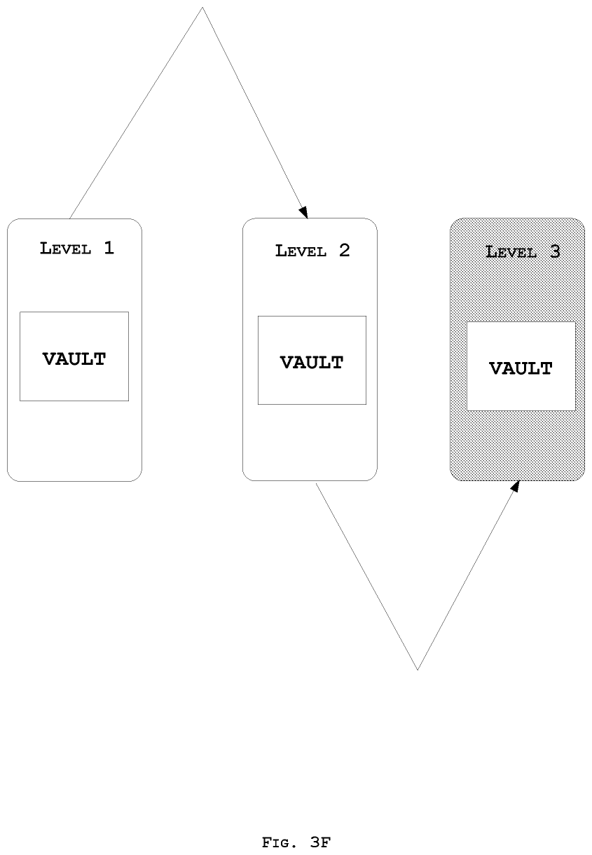

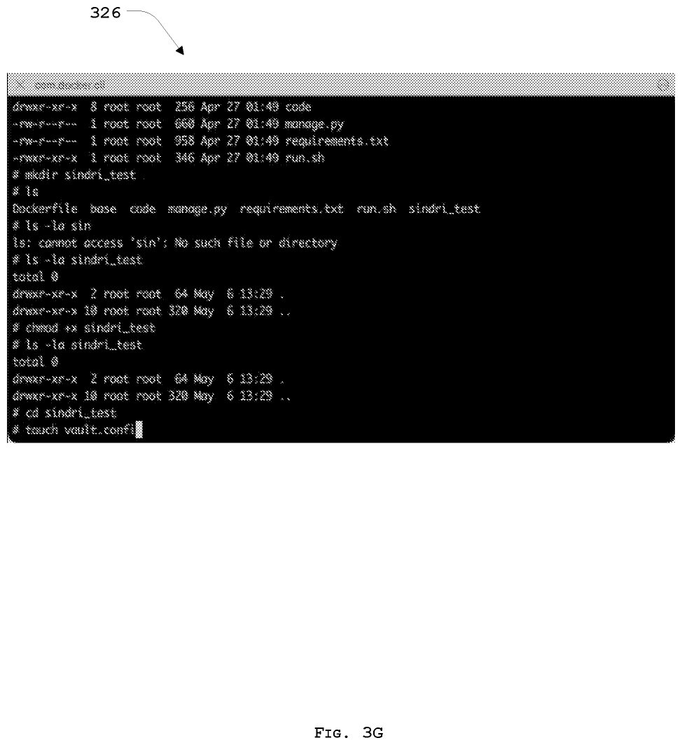

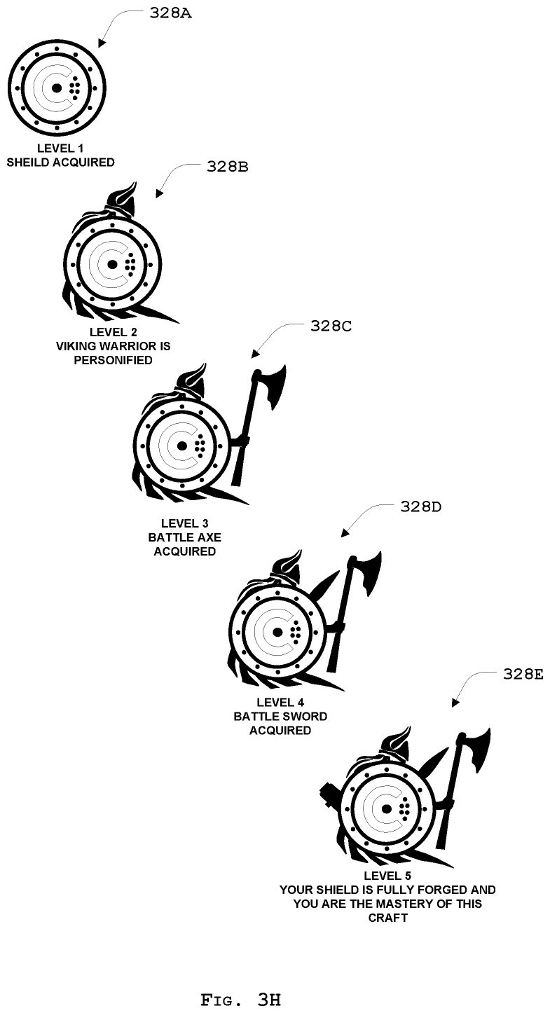

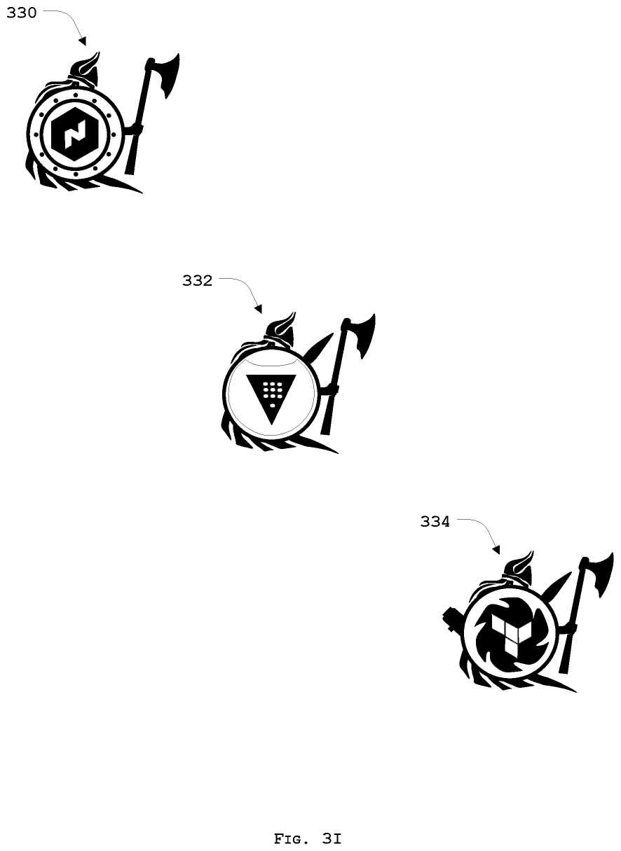

FIG. 3A shows a schematic block diagram with the one or more modules 116 of the processing unit 102 for forging the shield for a user 302. In a real-time scenario, when the user 302 logs-in to an account for forging the shield, the options displaying module 202 may be configured to display options to the user 302. The options may include plurality of technical skills for which a shield may be forged. The processing unit 102 may be pre-configured to be capable of conducting the assessment and forging the shield for the plurality of technical skills. FIG. 3B shows an exemplary representation of a Graphical User Interface (GUI) 304 of the user 302 provided with options of plurality of technical skills 308. The user 302 may log-in or sign-up to forge the shield by clicking the icon “LOGIN/SIGNUP”. Further, upon logging-in, the user 302 may click the icon 306 “forge a shield”, to initiate the forging. Upon clicking the icon 306, the options with the plurality of the technical skills may pop up on the GUI 304. In an embodiment, when the user 302 is a new user who has logged in for the first time or who has not forged a shield previously, such user may initiate the forging by selecting one of the plurality of technical skills 308. In another embodiment, when the user 302 is already associated with shield which is previously forged, the GUI 304 may prompt the user 302 to take up forging of a shield for next level of the same technical skills, along with other technical skills. In an embodiment, the GUI 304 may also provide option to choose skill level for which the shield is to be forged, the skill level may define the user's level of knowledge on a particular skill. For example, if the skill level is level 1, the user 302 may have basic knowledge on the technical skill. If the skill level is level 5, the user 302 may be an expert in the technical skill. In an embodiment, the skill level may be automatically selected based on previously shields owned by the user 302. For example, when the user possess a shield for Vault level 2, when the user 302 logs-in or selects the technical skill as Vault, the skill level for the assessment may be automatically selected to be level 3. The request 220 for forging the shield for a selected technical skill may be generated when the user 302 selects a technical skill amongst the plurality of technical skills 308, and optionally a skill level. The GUI 304 may be rendered to the user 302 via the communication network 104.

The forge request obtaining module 204 may be configured to obtain the request 220 from the user 302. The request 220 may include information on the selected technical skill and the skill level. The skill level may be selected by the user 302 or automatically selected based on profile of the user 302. In an embodiment, the request 220 may be obtained by the forge request obtaining module 204 via the communication network 104. In an embodiment, the request 220 may be obtained in form of a command by the forge request obtaining module 204.

Upon receiving the response, the simulation environment presenting module 206 may be configured to present a simulated environment 222 to the user 302. In an embodiment, the simulated environment 222 may be presented to the user 302 via the simulated network 106. In response to the request 220, the simulation environment presenting module 206 may be configured to dynamically spin off or generate the simulated environment 222 using a set of required infrastructures and technical skill components along with at-least one dynamically created problem for conducting an assessment of the user 302 for the selected technical skill. The problem for the simulated environment 222 is chosen based on the skill level. FIG. 3C shows an exemplary representation of a simulated environment 310 generated and presented to the user 302 by the simulation environment presenting module 206. In an embodiment, when the request 220 to forge a shield for the selected technical skill is obtained, the simulated environment 310 may be generated by selecting required set of infrastructures 316 and technical skill components 318. An AMI 320 associated with the selected technical skill and the skill level may be retrieved from AMI repository 324. The AMI repository 324 may include pre-built AMIs associated with each of the plurality of technical skills and each of the plurality of skill levels. The suitable AMI 320 along with the set of the required infrastructure 316 and the technical skill components 318 form the simulated environment 310.

The user 312 may be able to access the simulated environment 310 via the simulated network 106. In an embodiment, the user 312 may be connected to a web browser 314 through Remote Desktop Protocol (RDP) and further to Windows browser 322 which is part of the simulated network 106. The Windows browser 322, through Secure Shell (SSH), may connect the user 302 with the AMI 320 along with the set of required infrastructures 316 and the technical skill components 318(i.e., the simulation environment). The set of required infrastructures 316 and the technical skill components 318 may be selected based on the technical skill selected by the user 302.

Consider the user 302 selects the technical skill as ELASTIC SEARCH for Level 3. A simulation environment 310A for the selected technical skill presented to the user 312 may be as shown in FIG. 3D. For simulating the assessment related to the ELASTIC SEARCH, assume the technical skill needs to be supported with Base VPC, NAT Gateway, AWS Routes, API, AWS Gateway, and Load Balancer. Thus, the set of required infrastructures 316 selected for generating the simulation environment 310A for the ELASTIC SEARCH may be Base VPC, NAT Gateway, AWS Routes, API, AWS Gateway, and Load Balancer, as shown in FIG. 3D. The AMI 320 selected from the AMI repository 324 may be an AMI associated with ELASTIC SEARCH Level 3. Further, the technical skills components 318 may be cluster of ELASTIC SEARCH servers. Such simulated environment 310A may be dynamically generated and presented to the user 312 for the assessment.

In another example, consider the user 302 selects the technical skill as VAULT for Level 2. A simulation environment 310B presented to the user 302 for the selected skill may be as shown in FIG. 3E. For simulating the assessment related to the VAULT, assume the technical skill needs to be supported with Base VPC, NAT Gateway, AWS Routes, API, AWS Gateway, and Load Balancer. Thus, the set of required infrastructures 316 selected for generating the simulation environment 310B for the ELASTIC SEARCH may be Base VPC, NAT Gateway, AWS Routes, API, AWS Gateway, and Load Balancer, as shown in FIG. 3E. The AMI 320 selected from the AMI repository 324 may be an AMI associated with VAULT Level 2. Further, the technical skills components 318 may be cluster of VAULT servers. Assume, CONSUL servers may also be required to support VAULT servers in the simulated environment 310B. In such case, cluster of CONSUL servers may also be added as the technical skill components 318 in the simulated environment 310B. Such simulated environment 310B may be dynamically generated and presented to the user 312 for the assessment.

In an embodiment, when spinning-off the simulated environment 222, the simulated environment presenting module 206 may be configured to spin-off previous level of the technical skill as well, as shown in FIG. 3F. Thus, when a user 302 requests for assessment of a technical skill at an advanced level, a progressive simulated environment 222 is generated for the user 302.

FIG. 3G shows an exemplary representation of a GUI 326 accessed by the user 302 when taking the assessment. The user 302 may be provided with one or more instructions on taking up the assessment. The user 302 may provide commands or processes to take the assessment and execute the code. For example, when the assessment is related to ELASTIC SEARCH, the assessment may include dynamically generated problems of accessing analytics of a remote website, log the analytics and create a visualizing data using the logged analytics. The user 302 may be displayed with generated problems. The user 302 may attempt to solve the problem by inputting commands and processes. Upon completing the assessment, the user 302 may submit the assessment. In an embodiment, the assessment may be allotted with a predefined time period. Upon completion of the predefined time period, the assessment may be automatically submitted.

Upon submission of the assessment, the assessment evaluating module 212 may be configured to evaluate the assessment based on end state 226 of the simulated environment 222. In an embodiment, the end state determining module 210 may be configured to run a script on the simulated environment 222, upon submission of the assessment, to determine the end state 226 of the simulated environment 222. The script may be pre-coded to check end state 226 of the simulated environment 222 for each of the problems in the simulated environment 222. In an environment, the end state 226 may be one of completed or failed. In another embodiment, the end state 226 may be determined by comparing the state of the simulated environment 222 with desired state. One or more techniques, known to a person skilled in the art may be implemented to determine the end state 226.

In an embodiment, evaluating the assessment includes to generate one or more scores for the assessment based on the end state 226 of the simulated environment 222. The score may be allotted based on end state 226 of the simulated environment 222 for each of the problems. Consider the previous example where the problems to be solved where accessing analytics of a remote website, log the analytics and create a visualizing data using the logged analytics. When the user 302 accesses the analytics successfully, a first score may be allotted to the user. Further, when the user 302 logs the analytics successfully, a second score may be provided and similarly, when the user 302 successfully visualizes the analytics, a third score may be allotted. The total score allotted to the user 302 may be total of the first score, the second score and the third score.

In an embodiment, the user input monitoring may be further configured to monitor one or more user inputs 224 provided by the user 302 in the simulated environment 222 during the assessment. The one or more inputs may be the commands and processes attempted by the user 302 during the assessment. In an embodiment, the one or more user inputs 224 may be used for evaluating the assessment of the user 302, upon submission of the assessment. Further, the one or more user inputs may be monitored and used for detecting act of cheating by the user 302 during the assessment. In an embodiment, the one or more user inputs 224 may be monitored by recording the screen of the assessment of the user 302. One or more other techniques, known to a person skilled in the art, may be implemented to monitor the one or more user inputs 224 during the assessment.

Further, upon submission of the assessment, the shield forging module 214 may be configured to forge a shield to certify the user 302to possess the selected technical skill with the skill level, based on the evaluation of the assessment. The information on shield, that may needs to be forged for the user, may be stored as the shield data 230 in the memory 118. In an embodiment, the shield is forged when value of one or more scores generated for the assessment is verified to be greater than a threshold value. In an embodiment, the one or more scores generated for the assessment may be stored as the assessment evaluation data 228 in the memory 118. In an embodiment, the shield is forged when the end state 226 of the simulated environment 222 is detected to be completed. FIG. 3H shows the shields forged for a technical skill at different skill levels. First shield 328A may be digitally forged for certifying the user 302 for level 1 of a first technical skill. Second shield 328B may be digitally forged for certifying the user 302 for level 2 of a first technical skill. Third shield 328C may be digitally forged for certifying the user 302 for level 3 of a first technical skill. Fourth shield 328D may be digitally forged for certifying the user 302 for level 4 of a first technical skill. Fifth shield 328E may be digitally forged for certifying the user 302 for level 5 of a first technical skill. Further, design of the shield may vary based on the selected technical skill as shown in FIG. 3I. Sixth shield 330 may be digitally forged for second technical skill. Seventh shield 332 may be digitally forged for third technical skill. Eight shield 334 may be digitally forged for fourth technical skill.

In an embodiment, the shield publishing module 216 may be configured to publish the forged shield in a social platform of the user 302. In an embodiment, the publishing of the forged shield may be initiated upon receiving request from the user 302.

In some non-limiting embodiments or aspects, the processing unit 102 may receive data for forging the shield via the I/O interface 114. The received data may include, but is not limited to, at least one of the request data 220, the user input data 224, and the like. Also, the processing unit 102 may transmit data for forging the shield via the I/O interface 114. The transmitted data may include, but is not limited to, the simulated environment data 222, the end state data 226, the assessment evaluation data 228, the shield data 230 and the like.

The other data 232 may comprise data, including temporary data and temporary files, generated by modules for performing the various functions of the processing unit 102. The one or more modules 116 may also include other modules 218 to perform various miscellaneous functionalities of the processing unit 102. It will be appreciated that such modules may be represented as a single module or a combination of different modules

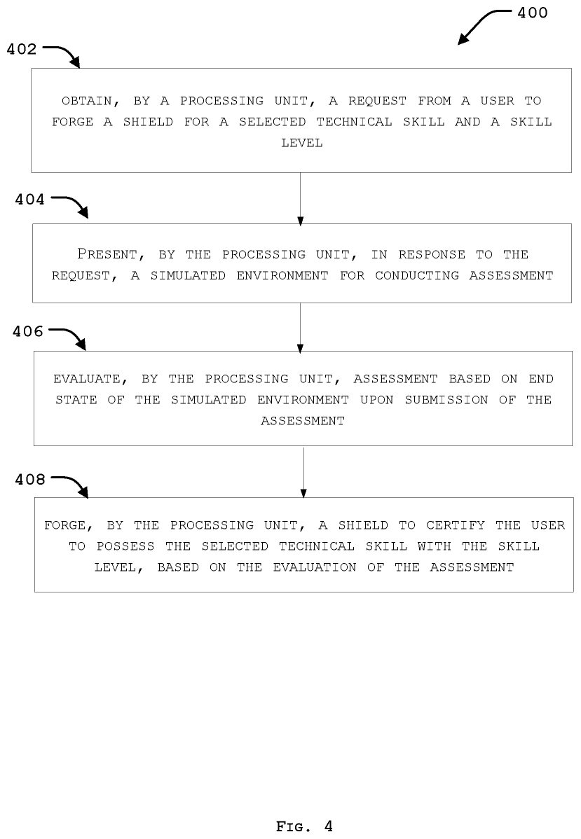

FIG. 4 shows an exemplary process of a processing unit for forging a shield to certify a user with a technical skill, in accordance with an embodiment of the present disclosure. Process 400 for forging the shield includes steps coded in form of executable instructions to be executed by a processing unit associated with user device connected with the user.

At block 402, the processing unit is configured to obtain a request from a user to forge a shield for a selected technical skill and a skill level. In an embodiment, options containing a plurality of technical skills, and optionally a plurality of skill levels may be displayed to the user to obtain the request from the user.

At block 404, in response to the request, the processing unit is configured to present a simulated environment generated using a set of required infrastructures and technical skill components along with at-least one dynamically created problem for conducting an assessment of the user for the selected technical skill. The problem for the simulated environment is chosen based on the skill level.

At block 406, upon submission of the assessment, the processing unit is configured to evaluate the assessment based on end state of the simulated environment. In an embodiment, the processing unit may be configured to run a script on the simulated environment, upon submission of the assessment, to determine the end state of the simulated environment. In an embodiment, evaluating the assessment includes to generate one or more scores for the assessment based on the end state of the simulated environment. In an embodiment, the processing unit may further be configured to monitor one or more user inputs 224 provided by the user in the simulated environment during the assessment. The one or more user inputs 224 are used for at least one of evaluating the assessment of the user, upon submission of the assessment and detecting act of cheating by the user during the assessment.

At block 408, the processing unit is configured to forge a shield to certify the user to possess the selected technical skill with the skill level, based on the evaluation of the assessment. In an embodiment, the shield is forged when at least one of value of one or more scores generated for the assessment is verified to be greater than a threshold value and the end state of the simulated environment is detected to be completed. In an embodiment, the forged shield may be published in a social platform of the user.

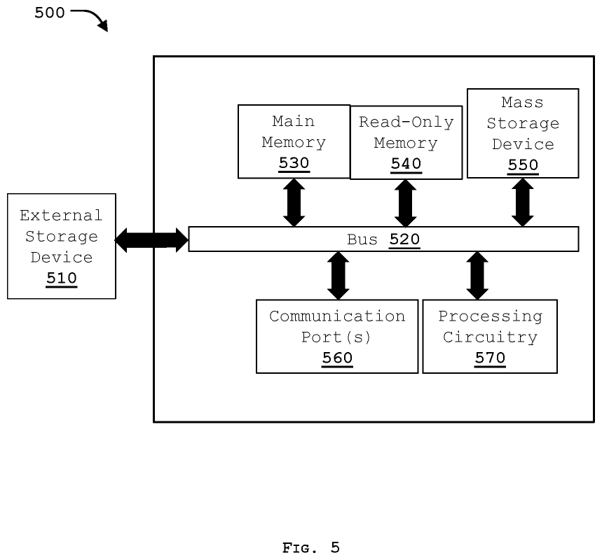

FIG. 5 illustrates an exemplary computer system in which or with which embodiments of the present invention may be utilized. Depending upon the particular implementation, the various process and decision blocks described above may be performed by hardware components, embodied in machine-executable instructions, which may be used to cause a general-purpose or special-purpose processor programmed with the instructions to perform the steps, or the steps may be performed by a combination of hardware, software and/or firmware. As shown in FIG. 5, the computer system 500 includes an external storage device 510, bus 520, main memory 530, read-only memory 540, mass storage device 550, communication port(s) 560, and processing circuitry 570.

Those skilled in the art will appreciate that the computer system 500 may include more than one processing circuitry 570 and one or more communication ports 560. The processing circuitry 570 should be understood to mean circuitry based on one or more microprocessors, microcontrollers, digital signal processors, programmable logic devices, Field-Programmable Gate Arrays (FPGAs), Application-Specific Integrated Circuits (ASICs), etc., and may include a multi-core processor (e.g., dual-core, quadcore, Hexa-core, or any suitable number of cores) or supercomputer. In some embodiments, the processing circuitry 570 is distributed across multiple separate processors or processing units, for example, multiple of the same type of processing units (e.g., two Intel Core i7 processors) or multiple different processors (e.g., an Intel Core i5 processor and an Intel Core i7 processor). Examples of the processing circuitry 570 include, but are not limited to, an Intel® Itanium® or Itanium 2 processor(s), or AMD® Opteron® or Athlon MP® processor(s), Motorola® lines of processors, System on Chip (SoC) processors or other future processors. The processing circuitry 570 may include various modules associated with embodiments of the present disclosure.

The communication port 560 may include a cable modem, Integrated Services Digital Network (ISDN) modem, a Digital Subscriber Line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of electronic devices or communication of electronic devices in locations remote from each other. The communication port 560 may be any RS-232 port for use with a modem-based dialup connection, a 10/100 Ethernet port, a Gigabit, or a 10 Gigabit port using copper or fiber, a serial port, a parallel port, or other existing or future ports. The communication port 560 may be chosen depending on a network, such as a Local Area Network (LAN), Wide Area Network (WAN), or any network to which the computer system 500 may be connected.

The main memory 530 may include Random Access Memory (RAM) or any other dynamic storage device commonly known in the art. Read-only memory (ROM) 540 may be any static storage device(s), e.g., but not limited to, a Programmable Read-Only Memory (PROM) chips for storing static information, e.g., start-up or BIOS instructions for the processing circuitry 570.

The mass storage device 550 may be an electronic storage device. As referred to herein, the phrase “electronic storage device” or “storage device” should be understood to mean any device for storing electronic data, computer software, or firmware, such as random-access memory, read-only memory, hard drives, optical drives, Digital Video Disc (DVD) recorders, Compact Disc (CD) recorders, BLU-RAY disc (BD) recorders, BLU-RAY 3D disc recorders, Digital Video Recorders (DVRs, sometimes called a personal video recorder or PVRs), solid-state devices, quantum storage devices, gaming consoles, gaming media, or any other suitable fixed or removable storage devices, and/or any combination of the same. Nonvolatile memory may also be used (e.g., to launch a boot-up routine and other instructions). Cloud-based storage may be used to supplement the main memory 530. The mass storage device 550 may be any current or future mass storage solution, which may be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firmware interfaces), e.g., those available from Seagate (e.g., the Seagate Barracuda 7200 family) or Hitachi (e.g., the Hitachi Deskstar 7K1000), one or more optical discs, Redundant Array of Independent Disks (RAID) storage, e.g., an array of disks (e.g., SATA arrays), available from various vendors including Dot Hill Systems Corp., LaCie, Nexsan Technologies, Inc. and Enhance Technology, Inc.

The bus 520 communicatively couples the processing circuitry 570 with the other memory, storage, and communication blocks. The bus 520 may be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processing circuitry 570 to the software system.

Optionally, operator and administrative interfaces, e.g., a display, keyboard, and a cursor control device, may also be coupled to the bus 520 to support direct operator interaction with the computer system 500. Other operator and administrative interfaces may be provided through network connections connected through the communication port(s) 560. The external storage device 510 may be any kind of external hard drives, floppy drives, IOMEGA® Zip Drives, Compact Disc-Read-Only Memory (CD-ROM), Compact Disc—Re-Writable (CD-RW), Digital Video Disk-Read Only Memory (DVD-ROM). The components described above are meant only to exemplify various possibilities. In no way should the aforementioned exemplary computer system limit the scope of the present disclosure.

The computer system 500 may be accessed through a user interface. The user interface application may be implemented using any suitable architecture. For example, it may be a stand-alone application wholly implemented on the computer system 500. The user interfaces application and/or any instructions for performing any of the embodiments discussed herein may be encoded on computer-readable media. Computer-readable media includes any media capable of storing data. In some embodiments, the user interface application is a client-server-based application. Data for use by a thick or thin client implemented on electronic device computer system 500 is retrieved on-demand by issuing requests to a server remote to the computer system 500. For example, computer system 500 may receive inputs from the user via an input interface and transmit those inputs to the remote server for processing and generating the corresponding outputs. The generated output is then transmitted to the computer system 500 for presentation to the user.

While embodiments of the present invention have been illustrated and described, it will be clear that the invention is not limited to these embodiments only. Numerous modifications, changes, variations, substitutions, and equivalents, will be apparent to those skilled in the art without departing from the spirit and scope of the invention, as described in the claims.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document, terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein but is to be accorded to the widest scope consistent with the principles and novel features disclosed herein. It is contemplated that additional embodiments are within the spirit and true scope of the disclosed subject matter.

We claim:

1. A method for forging a shield to certify a user with a technical skill, the method comprising:
obtaining, by a processing unit, a request from a user to forge a shield for a selected technical skill and a skill level;
in response to the request, presenting, by the processing unit, a simulated environment generated using a set of required infrastructures and technical skill components along with at-least one dynamically created problem for conducting an assessment of the user for the selected technical skill, wherein the problem for the simulated environment is chosen based on the skill level;
upon submission of the assessment, evaluating, by the processing unit, the assessment based on end state of the simulated environment; and
forging, by the processing unit, a shield to certify the user to possess the selected technical skill with the skill level, based on the evaluation of the assessment.

2. The method of claim 1, further comprising:
displaying, by the processing unit, options containing a plurality of technical skills, and optionally a plurality of skill levels, to the user to obtain the request from the user.

3. The method of claim 1, wherein evaluating the assessment comprises:
generating, by the processing unit, one or more scores for the assessment based on the end state of the simulated environment.

4. The method of claim 1, further comprising:
monitoring one or more user inputs provided by the user in the simulated environment during the assessment, wherein the one or more user inputs are used for at least one of:
evaluating the assessment of the user, upon submission of the assessment; and
detecting act of cheating by the user during the assessment.

5. The method of claim 1, wherein the shield is forged when at least one of:
value of one or more scores generated for the assessment is verified to be greater than a threshold value; and
the end state of the simulated environment is detected to be completed.

6. The method of claim 1, further comprising:
publishing, by the processing unit, the forged shield in a social platform of the user.

7. The method of claim 1, further comprising:
running, by the processing unit, a script on the simulated environment, upon submission of the assessment, to determine the end state of the simulated environment.

8. A processing unit for forging a shield to certify a user with a technical skill, the processing unit comprises:
one or more processors; and
a memory communicatively coupled to the one or more processors, wherein the memory stores processor-executable instructions, which, on execution, cause the one or more processors to:
obtain a request from a user to forge a shield for a selected technical skill and a skill level;
in response to the request, present a simulated environment generated using a set of required infrastructures and technical skill components along with at-least one dynamically created problem for conducting an assessment of the user for the selected technical skill, wherein the problem for the simulated environment is chosen based on the skill level;
upon submission of the assessment, evaluate the assessment based on end state of the simulated environment; and
forge a shield to certify the user to possess the selected technical skill with the skill level, based on the evaluation of the assessment.

9. The processing unit of claim 8, wherein the one or more processors are further configured to:
display options containing a plurality of technical skills, and optionally a plurality of skill levels, to the user to obtain the request from the user.

10. The processing unit of claim 8, wherein the one or more processors are configured to evaluate the assessment by:
generating one or more scores for the assessment based on the end state of the simulated environment.

11. The processing unit of claim 8, wherein the one or more processors are further configured to:
monitor one or more user inputs provided by the user in the simulated environment during the assessment, wherein the one or more user inputs are used for at least one of:
evaluating the assessment of the user, upon submission of the assessment; and
detecting act of cheating by the user during the assessment.

12. The processing unit of claim 8, wherein the one or more processors are configured to forge the shield when at least one of:
value of one or more scores generated for the assessment is verified to be greater than a threshold value; and
the end state of the simulated environment is detected to be completed.

13. The processing unit of claim 8, wherein the one or more processors are further configured to:
publish the forged shield in a social platform of the user.

14. The processing unit of claim 8, wherein the one or more processors are further configured to:
run a script on the simulated environment, upon submission of the assessment, to determine the end state of the simulated environment.

15. A non-transitory computer-readable medium including instructions stored thereon that when processed by one or more processors cause a processing unit to perform operations comprising:
obtaining a request from a user to forge a shield for a selected technical skill and a skill level;
in response to the request, presenting a simulated environment generated using a set of required infrastructures and technical skill components along with at-least one dynamically created problem for conducting an assessment of the user for the selected technical skill, wherein the problem for the simulated environment is chosen based on the skill level;
upon submission of the assessment, evaluating the assessment based on end state of the simulated environment; and
forging a shield to certify the user to possess the selected technical skill with the skill level, based on the evaluation of the assessment.

16. The medium of claim 15, further comprising:
displaying options containing a plurality of technical skills, and optionally a plurality of skill levels, to the user to obtain the request from the user.

17. The medium of claim 15, wherein evaluating the assessment comprising:
generating one or more scores for the assessment based on the end state of the simulated environment.

18. The medium of claim 15, further comprising:
monitoring one or more user inputs provided by the user in the simulated environment during the assessment, wherein the one or more user inputs are used for at least one of:
evaluating the assessment of the user, upon submission of the assessment; and
detecting act of cheating by the user during the assessment; and
running a script on the simulated environment, upon submission of the assessment, to determine the end state of the simulated environment.

19. The medium of claim 15, wherein the shield is forged when at least one of:
value of one or more scores generated for the assessment is verified to be greater than a threshold value; and
the end state of the simulated environment is detected to be completed.

20. The medium of claim 15, further comprising:
publishing the forged shield in a social platform of the user.
